(19) United States
(12) Patent Application Publication
(10) Pub. No.: US 2003/0059158 A1
(43) Pub. Date: Mar. 27, 2003

(54) Broadcast network using multi-fiber cable

(76) Inventor: Jonathan Lacey, Mountain View, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/965,537

(22) Filed: Sep. 26, 2001

(51) Int. Cl. G02B 6/28; G02B 6/44; H04B 10/12

(52) U.S. Cl. 385/24; 385/100; 359/173

(57) ABSTRACT

A broadcast network for broadcasting an optical signal to a plurality of end users at different locations. The network employs a multi-optical-fiber cable with a plurality of individual fibers, where the number of individual fibers corresponds to the number of end users. An optical transmitter is provided for launching the optical signal to be broadcast into all the individual fibers. As the optical fiber cable passes each user, an individual optical fiber associated with the particular end user is split off from the multi-optical-fiber cable and terminates at the particular end user. The network includes a branch point, where the individual fibers branch out to the individual users.

### FIELD OF THE INVENTION

The present invention relates generally to high-bandwidth broadcast networks, and more particularly, to a broadcast network that utilizes multi-optical-fiber cable.

### BACKGROUND OF THE INVENTION

Cable television is prevalent in many homes across the country. In some locations, television sets are not able to receive broadcasts without cable TV because of geographic barriers and other sources of interference of the broadcast signal. In addition, even for those located in a place where a television can receive the local broadcast channels, there is an ever-increasing demand for value-added channels, such as dedicated new channels, dedicated sports channels, dedicated music video channels, dedicated movie channels, etc. The average consumer has come to expect hundreds of channels to be offered by a local cable company.

Unfortunately, as the demand grows for more programming and as display technologies advance, there is an ever-increasing need for broadcast networks that are capable of supplying high bandwidth in a cost-effective manner. For example, high definition television signals require more bandwidth per channel in order to provide a richer viewing experience. Similarly, the number of channels that are provided by cable companies is ever increasing to keep up with the demand of the consumers.

In the past, many cable TV networks have been built using coaxial copper cable (coax) as the only transmission medium. Coaxial cable provides more transmission bandwidth than simple copper wire, but these so-called pure coax systems suffer from several disadvantages. First, although coax cable has more transmission bandwidth than simple copper wire, its transmission bandwidth is limited, and it is difficult to transmit many high-bandwidth signals over long distances using coax. Consequently, these systems are generally unable to accommodate the increased demand for bandwidth. Second, these systems are generally very expensive to install and maintain because of the large amount of active equipment (i.e., equipment that requires electrical power to function) in the field. For example, coax transmitters, coax receivers, coax amplifiers, and coax splitters are located in the field and require electrical power to operate. These active elements are required to overcome the limited transmission bandwidth of coax.

Being in the field, the equipment is susceptible to nature (e.g., poor weather conditions) and human forces (e.g., vandalism). Moreover, the costs to repair or maintain the equipment are high. For example, when a piece of equipment fails, personnel are required to locate the equipment and often repair or replace the equipment in the field.

These types of systems also raise some complex transmission design issues since the signal is typically split off from a bus for each user. The users closer to the signal source or repeater receive a stronger and less noisy signal than those users who are further away from the source.

Furthermore, these systems typically require the cable TV company to provide a cable set-top box that has relatively complex hardware to decode the signals. This hardware raises the costs of providing cable TV service since the cost of the box is eventually passed onto the customer.

To address some of these issues, some cable companies have switched from a pure coax system to a hybrid fiber-coax (HFC) network. An example of this approach is described in a publication entitled, “Broadband Hybrid Fiber/Coax Access System Technologies (Series in Telecommunications),” Academic Press, 1998.

FIG. 1 illustrates a prior art hybrid fiber-coax (HFC) broadcast network 1. These HFC networks typically include an optical transmitter 2, disposed at a central office 3, an optical fiber 4, and an optical receiver 5. The transmitter 2, receiver 5 and the optical fiber 4 enable optical transmission of the broadcast signals to a coaxial-cable bus network 7. The coaxial-cable bus network 7 then distributes the signal to the individual consumers or users. The network 7 includes a coaxial transmitter 8, coaxial cable 9, a plurality of amplifiers 10 and splitters 11 for delivering the broadcast signals to each user. Each user also has a coaxial receiver 12 for receiving and decoding the broadcast signals and providing the signals to the home network 14.

One advantage of HFC networks over pure coax networks is that the transmission bandwidth of the HFC networks is much greater than the transmission bandwidth of coax. HFC networks typically use fiber transmission for long spans from the hub, or central office, to a coaxial cable network 7, thereby replacing a coax transmission system that typically has many amplifiers with a much simpler fiber transmission system.

Unfortunately, the coax part of HFC networks continues to suffer from some of the disadvantages of the pure coax networks. These disadvantages include high costs to install an maintain active equipment in the field, reliability issues as they relate to the equipment, high cost of the receiver at the consumer's home, and transmission design complexities.

Consequently, it is desirable for there to be a broadcast network that reduces the number of active equipment in the field, simplifies transmission design of the system, and reduces the cost of the receiver required by the consumer.

Based on the foregoing, there remains a need for a broadcast network that overcomes the disadvantages set forth previously.

### SUMMARY OF THE INVENTION

According to one embodiment of the present invention, a broadcast network for broadcasting an optical signal to a plurality of end users at different locations is described. The network employs a multi-optical-fiber cable with a plurality of individual fibers, where the number of individual fibers corresponds to the number of end users. An optical transmitter is provided for launching the optical signal to be broadcast into all the individual fibers. As the optical fiber cable passes each user, an individual optical fiber associated with the particular end user is split off from the multi-optical-fiber cable and terminates at the particular end user. The network includes a branch point, where the individual fibers branch out to the individual users.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a prior art hybrid fiber-coax (HFC) broadcast network.

FIG. 2 illustrates a broadcast network according to one embodiment of the present invention.

FIG. 3 illustrates an exemplary physical implementation of the broadcast network of FIG. 2 in accordance with one embodiment of the present invention.

FIG. 4 illustrates in greater detail the branch point of FIG. 2 that is implemented as a tree of 1×2 splitters in accordance with one embodiment of the present invention.

FIG. 5 illustrates in greater detail the branch point of FIG. 2 that is implemented as a free-space 1×N splitter in accordance with one embodiment of the present invention.

FIG. 6 illustrates in greater detail the branch point of FIG. 2 that is implemented with an optical booster amplifier and a 1×N splitter in accordance with an alternative embodiment of the present invention.

FIG. 7 illustrates a broadcast network in which the branch point is located in a central office in accordance with one embodiment of the present invention.

FIG. 8 illustrates a broadcast network in which the branch point is located in the field in accordance with one embodiment of the present invention.

FIG. 9 illustrates a broadcast network that employs route diversity for enhanced reliability.

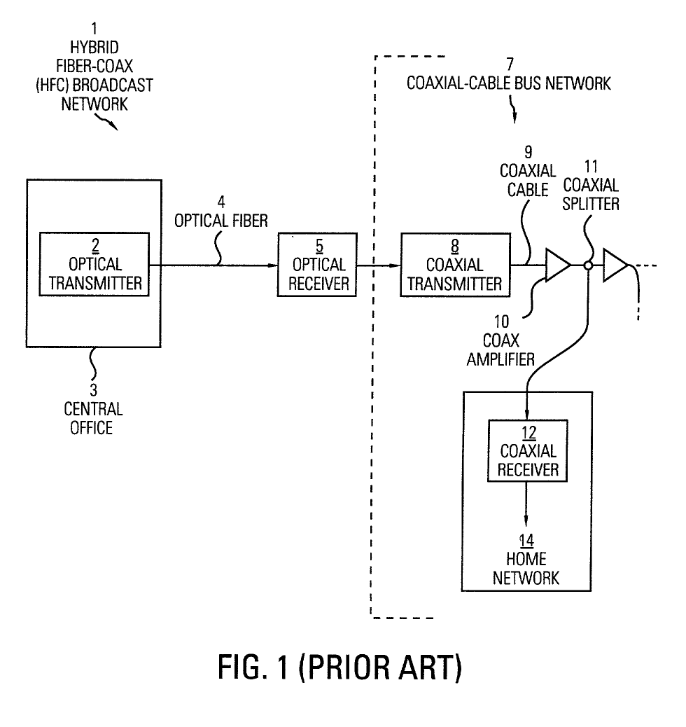

### DETAILED DESCRIPTION

A broadcast network that uses a multi-optical-fiber cable is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

The broadcast network of the present invention broadcasts an optical signal to a plurality of end users at different locations. The broadcast network employs an optical fiber cable that includes a plurality of individual fibers, where the number of individual fibers corresponds to the number of end users.

Broadcast Network 200

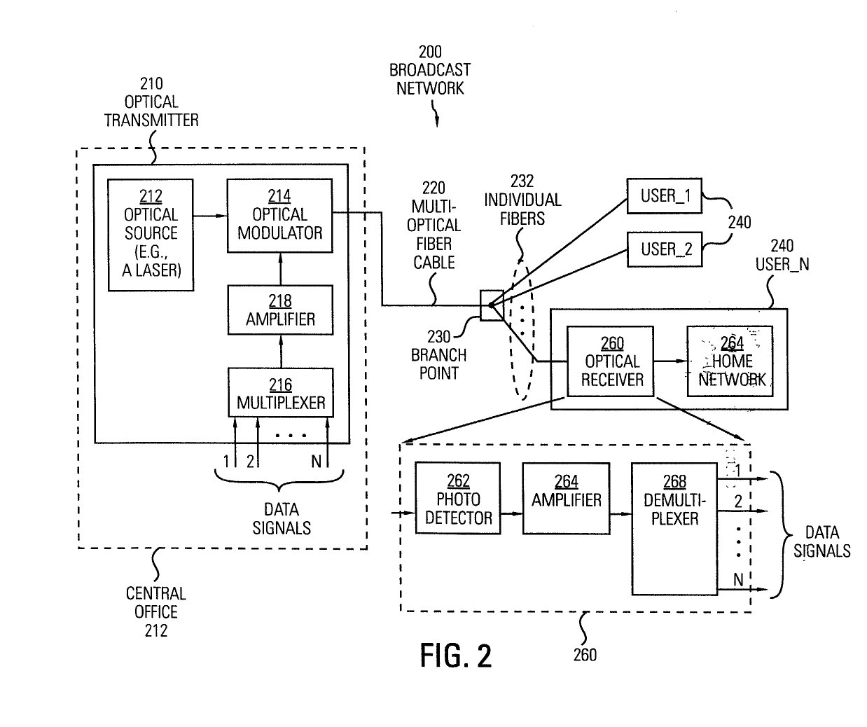

FIG. 2 illustrates a logical topology of a broadcast network 200 according to one embodiment of the present invention. The broadcast network 200 includes an optical transmitter 210, a multi-optical-fiber cable 220, a branch point 230, and a plurality of users 240 (e.g., user_{—}1, user_{—}2, . . . , user_N). The optical transmitter 210 launches the optical signal to be broadcast into all the individual fibers 232 of the cable 220. For example, the same broadcast signal may be launched into all the individual fibers 232.

At the branch point 230, the individual fibers 232 of the multi-optical-fiber cable 220 (e.g., a multi-fiber cable) branch out to the individual users 240. For example, in this embodiment, there are N individual fibers, one fiber for each user. As described in greater detail hereinafter, each user 240 can include a home network 264 and an optical receiver 260 for receiving the broadcast signal.

Each user 240 is equipped with an optical receiver 260 that is coupled to receive a respective fiber 232. The optical receiver 260 decodes the received broadcast signal and provides the decoded signal to a local network 264 (e.g., a home network).

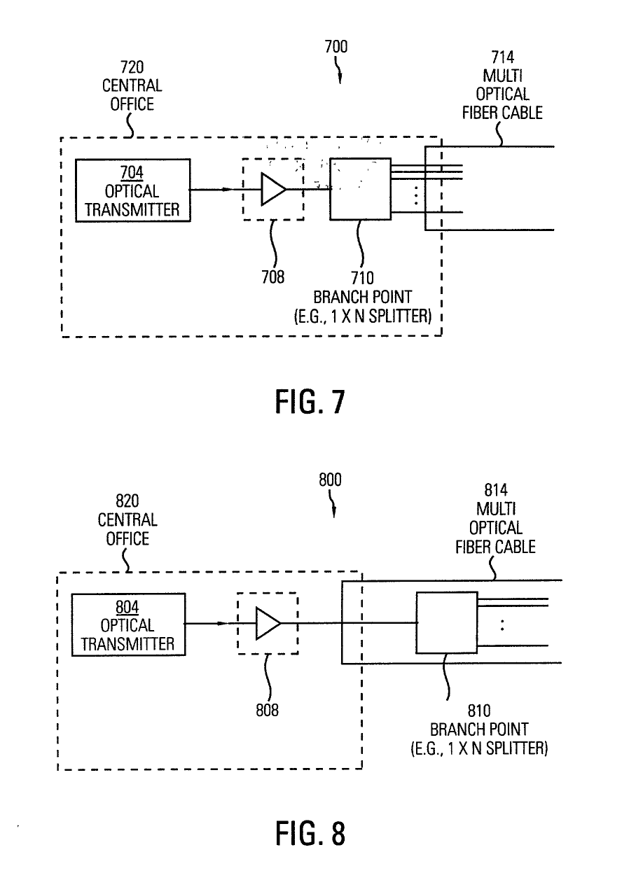

The optical transmitter 210 is preferably disposed in a central office 212. As described in greater detail hereinafter with reference to FIGS. 7 and 8, the branch point 230 may be disposed either in the central office 212 or in the field.

Single points of failure for a network are those components whose failure results in loss of the signal to all users. It is noted that the single points of failure for the network 200 of the present invention are components upstream of the branch point 230. Moreover, all these components are passive (i.e., do not require a source of power), and hence, are highly reliable. Furthermore, as described previously, the optical transmitter 210 is preferably placed in the central office 212, which is a safe environment. A redundant optical transmitter (not shown) may be employed to further increase reliability of the broadcast network 200.

Optical Transmitter 210

The optical transmitter 210 includes an optical source 212 (e.g., a laser) for providing an optical signal and an optical modulator 214 that is coupled to the optical source 212 for modulating the optical signal with data to generate a modulated optical signal. Preferably, the optical transmitter 210 also includes a multiplexer 216 for receiving a plurality of data signals (e.g., data_{—}1, data_{—}2, data_N) and based thereon for generating a multiplexed data signal. An amplifier 218 may be coupled to the multiplexer 216 for amplifying the output of the multiplexer 216. It is noted that the amplifier 218 and the multiplexer 216 are optional components.

Optical Receiver 260

The optical receiver 260 includes a photodetector 262 for receiving a modulated optical signal that includes data signals and for demodulating the modulated optical signal to recover the data signals. An amplifier 264 may be connected to the photodetector 262 to amplify the output of the photodetector 262. In some embodiments, where the transmitter 210 is provided with a multiplexer 216, the optical receiver 260 includes a de-multiplexer 268 for receiving a recovered multiplexed data signal and based thereon for generating the individual data signals.

One aspect of the present invention is to minimize the cost of the equipment required at the receive end (e.g., at each user 240). In the multi-user broadcast network 200 of the present invention, each user 240 is only required to have a single optical receiver (e.g., optical receiver 260), thereby reducing the costs at the receive end.

It is noted that in the preferred embodiment, the broadcast network 200 of the present invention splits the broadcast signal equally between the individual fibers in the multi-optical-fiber cable. It is further noted that the transmission loss of optical fiber is very low. Consequently, each user 240 receives a signal with approximately the same power independent of 1) how far the users are from the branch point or 2) how many other users are upstream of them. By utilizing an all-fiber system, the broadcast network 200 of the present invention simplifies network design and reduces the cost of optical receivers (e.g., optical receiver 260) because the optical receivers are not required to have a large dynamic range.

Since no coax is utilized in this network 200, the network 200 is also referred to herein as an “all-optical” network 200. The all-optical network 200 of the present invention is especially suited to broadcast high bandwidth signals (e.g., cable programming with many different channels and high definition television signals). For example, the broadcast network of the present invention may be utilized to implement a high-bandwidth, unidirectional (i.e., downstream only) broadcast networks.

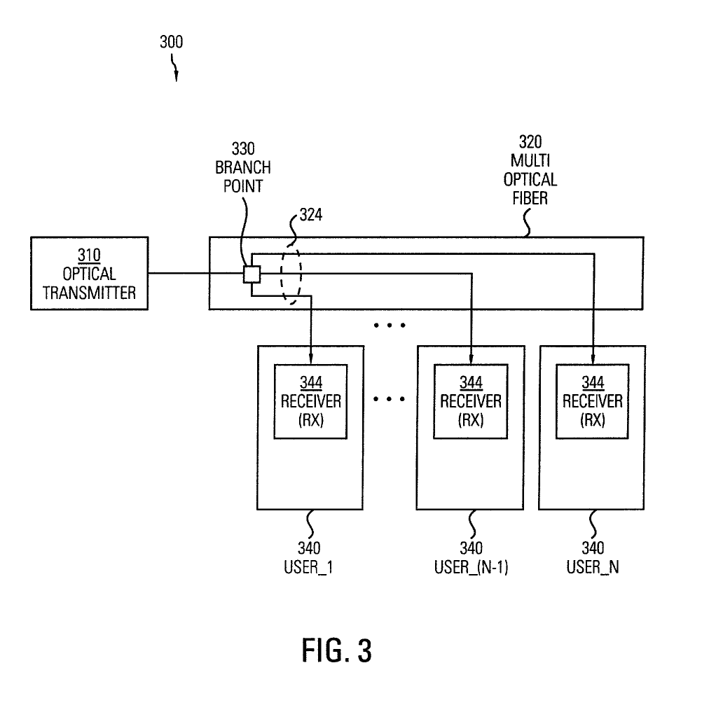

FIG. 3 illustrates an exemplary implementation of the broadcast network of FIG. 2 in accordance with one embodiment of the present invention. The broadcast network 300 of the present invention employs an optical transmitter 310 to broadcast a single optical signal to many end users at different locations. The network 300 utilizes a multi-optical-fiber cable 320 that preferably includes as many individual optical fibers 324 as there are end users (e.g., user_{—}1, . . . , user_(N−1), user_N).

The optical signal to be broadcast is first launched into all the individual fibers 324 of the multi-optical-fiber cable 320. The multi-optical-fiber cable 320 is situated or positioned to pass all the users 340. As the multi-optical-fiber cable 320 passes each user 340, an individual fiber that is associated with the particular end user is split off from the multi-optical-fiber cable 320 and terminates at a particular end user 340. In other words, an individual optical fiber from the multioptical-fiber cable 320 is routed to each user as the cable 320 passes each user's location.

In this implementation, the “arms” of the logical star, illustrated in FIG. 2, that are disposed downstream of the branch point 330, are contained in a single optical fiber cable. Each user 340 includes an optical receiver (optical Rx) 344 for receiving the broadcast optical signal. The components shown in FIG. 3 are substantially the same as those described in connection with the network of FIG. 2. Consequently, for the sake of brevity, the description is not repeated herein.

Branch Point 230

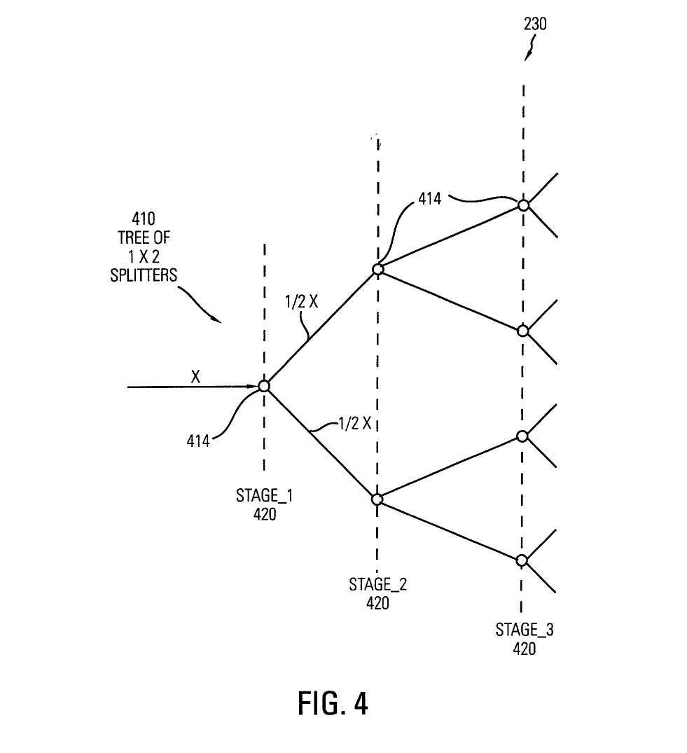

FIG. 4 illustrates in greater detail the branch point 230 of FIG. 2 that is implemented as a tree of 1×2 splitters in accordance with one embodiment of the present invention. In this embodiment, the branch point includes a tree 410 of splitters 414. The tree 410 includes a plurality of stages 420 (e.g., stage_{—}1, stage_{—}2, and stage_{—}3). It is noted that the number (M) of stages satisfies the equation, 2ˆ M=N, where N is the number of outputs of the branch point 230. Each stage 420 includes one or more 1×2 splitters 414. At each stage, the splitter 414 splits the incoming signal into two signals, where each signal is one-half the signal strength of the incoming signal.

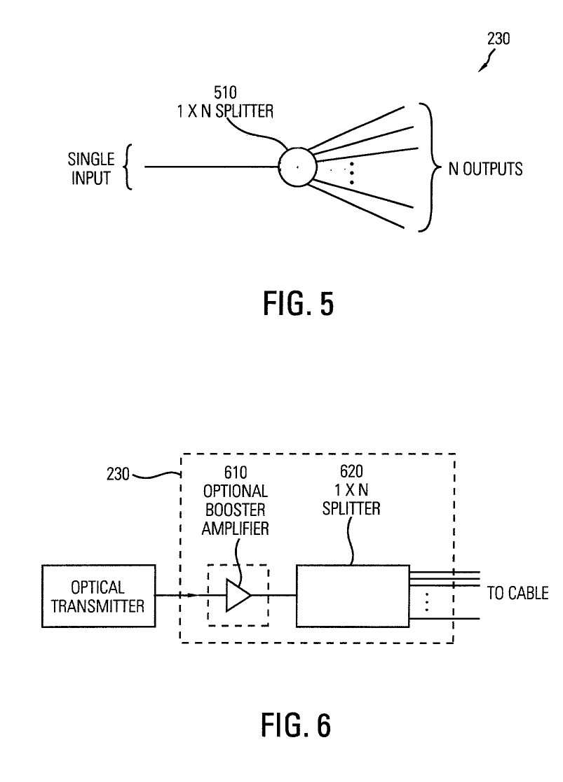

FIG. 5 illustrates in greater detail the branch point 230 of FIG. 2 that is implemented as a 1×N splitter in accordance with one embodiment of the present invention. The 1×N splitter 510 includes an input for receiving an incoming signal and N outputs. The 1×N splitter 510 splits the incoming signal into N signals, where the signal strength of each of the N signals is 1/N the strength of the incoming signal. It is noted that that the 1×N splitter 510 may be implemented with a free space star coupler (e.g., as used in arrayed-waveguide gratings (AWG)), an optical fiber splitter, or a planar waveguide splitter.

Single-mode optical power splitters, that are typically available in 1×n and 2×n configurations, uniformly divide optical signals from input ports to multiple outputs. Splitters can have a plurality of output ports. For example, splitters are commonly found with 4, 8, 16 or 32 output ports. It is noted that splitters can be operated in the reverse direction to combine multiple wavelengths onto 1 or 2 fibers.

Optical power splitting can also be performed by planar silica glass optical waveguide chips integrated with cascaded y-branches. Preferably, planar-type devices are utilized in order to leverage their high uniformity, low insertion loss, broadband performance over both 1310 nm and 1550 nm windows, compact size, environmentally stable nature, and compact packaging. For example, model number SM-1×32-M-xy splitter module that is available from JDS Uniphase of Columbus, Ohio can be utilized.

FIG. 6 illustrates in greater detail the branch point 230 of FIG. 2 that is implemented with a booster amplifier 610 and a 1×N splitter 620 in accordance with an alternative embodiment of the present invention. In this embodiment, the branch point 230 includes an optional booster amplifier 610 and a 1×N splitter 620. The 1×N splitter 620 is described previously with reference to FIG. 5. An optional booster amplifier 610 may be included to partially overcome or to completely overcome the loss of the splitter 620. It is noted that an optional booster amplifier may also be included in other embodiments of the present invention.

Although the different embodiments of the branch point 230 have been described with respect to the broadcast network of FIG. 2, it will be appreciated by those of ordinary skill in the art that the different embodiments of the branch point can also be utilized in other embodiments of the all-optical broadcast network of the present invention (e.g., in the broadcast network of FIG. 3).

FIG. 7 illustrates a broadcast network 700 in which the branch point 710 is located in a central office 720 in accordance with one embodiment of the present invention. In this embodiment, the all-optical broadcast network 700 includes an optical transmitter 704, an optional booster amplifier 708, a branch point 710, a multi-optical-fiber cable 714, and a plurality of optical receivers (not shown). According to this embodiment, the branch point 710 (e.g., a 1×N splitter) is disposed in the central office 720.

This embodiment is preferred when the first user is disposed in close proximity to the central office 720. It is noted that this embodiment may be more reliable than the embodiment described hereinafter with reference to FIG. 8 since the branch point 710 is located in the central office 720.

FIG. 8 illustrates a broadcast network 800 in which the branch point 810 is located in the field in accordance with one embodiment of the present invention. In this embodiment, the all-optical broadcast network 800 includes an optical transmitter 804, an optional booster amplifier 808, a branch point 810, a multioptical-fiber cable 814, and a plurality of optical receivers (not shown). According to this embodiment, the branch point 810 (e.g., a 1×N splitter) is disposed outside of the central office 820. It is noted that the branch point 810 can be disposed inside or outside of the multi-optical-fiber cable 814. This embodiment is preferred when the first user is disposed far from the central office 820.

For both embodiments described with reference to FIGS. 7 and 8, when a booster amplifier is employed, it is preferable to locate the booster amplifier in the central office. When the booster amplifier is disposed in the central office, the amplifier's power supply and reliability may be guaranteed, and the signal-to-noise ratio of the boosted signal may be maximized.

Broadcast Network 900 With Route Diversity

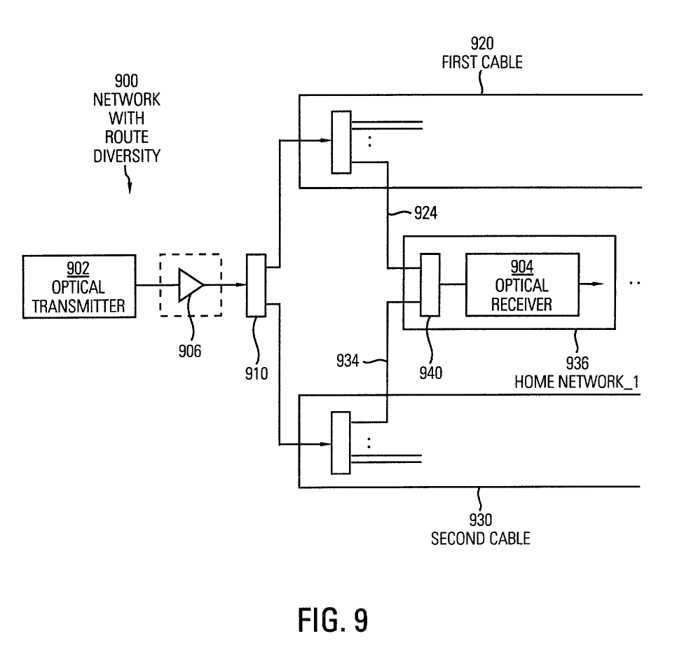

FIG. 9 illustrates a broadcast network 900 that employs route diversity for enhanced reliability. The network 900 includes an optical transmitter 902 at the transmit end, an optical receiver 904 at the receive end, and optionally a booster amplifier 906. The network 900 also includes a 1×2 element 910 at the transmit end. The 1×2 element 910 includes an input and two outputs.

The network 900 also includes at least two different cables (e.g., a first multi-optical-fiber cable 920 and a second multi-optical-fiber cable 930) that are respectively coupled to the outputs of the 1×2 element 910. The signal passes through the 1×2 element 910 and may be sent through either the first multioptical-fiber cable 920, the second multi-optical-fiber cable 930, or through both multi-optical-fiber cables 920, 930.

Each user (e.g., a first home network 936) receives both an individual optical fiber (e.g., optical fiber 924) from the first multi-optical-fiber cable 920 and an individual optical fiber (e.g., optical fiber 934) from the second multioptical-fiber cable 930. In this manner, a broadcast signal may be provided to each user by at least two different routes. Consequently, when one cable is cut, the users can still receive a signal from the other cable. The broadcast network 900 according to this embodiment of the present invention employs this scheme, which is referred to as route diversity, in order to increase the reliability of the network.

The network 900 also includes a 2×1 element 940 at the receive end (e.g., in the home network 936). The 2×1 element 940 includes two inputs and an output. The 2×1 element 940 can be implemented with a combiner or an optical switch.

In one embodiment, the 1×2 element 910 at the transmit end is implemented with a splitter, and the element 940 in each home is implemented with a switch that selects the working cable and feeds the output of the working cable to the receiver. When the receiver detects a loss of signal, the optical receiver 904 commands the switch to switch from the current cable to the other cable. In this embodiment, the signal is broadcast on both the first cable 920 and the second cable 930. This alternative embodiment is conventionally referred to as a 1+1 scheme.

In an alternative embodiment, the 1×2 element 910 at the transmit end is implemented with a switch, and the element 940 in each home is implemented with a coupler (i.e., a reversed splitter). When one cable is cut, the optical transmitter 902 is notified, and the optical transmitter 902 employs the switch to switch the signal to the un-cut cable. In this embodiment, the signal is broadcast on one cable at a time. Network level intelligence and a signaling mechanism are required to determine which cable to utilize for a broadcast. This alternative embodiment is conventionally referred to as a 1:1 scheme (“one-for-one” scheme).

Since the all-optical broadcast network of the present invention requires fewer or no active equipment in the field, the reliability of such a broadcast network is greater than prior art coax networks and hybrid (HFC) networks. Furthermore, by reducing the number of active equipment needed in the field, the costs to maintain the broadcast network of the present invention is less than prior art networks. The receivers utilized in the all-optical broadcast network of the present invention have a simpler design than the receivers utilized in the prior art networks.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A broadcast network comprising:
a) an optical transmitter for broadcasting a single optical signal to a plurality of end users at different locations;
b) an optical fiber cable that includes a plurality of individual fibers; wherein the number N of individual fibers corresponds to the number of end users; and
c) a branch point where the individual fibers branch out to the individual users.

2. The broadcast network of claim 1 wherein the network is arranged as a logical star.

3. The broadcast network of claim 1 wherein the network is arranged as a physical bus.

4. The broadcast network of claim 1 wherein the branch point includes a tree of 1×2 splitters.

5. The broadcast network of claim 1 wherein the branch point includes a 1×N splitter that includes an input.

6. The broadcast network of claim 5 wherein the 1×N splitter is implemented with one of a free space star coupler, an optical fiber splitter, and a planar waveguide splitter.

7. The broadcast network of claim 5 wherein the branch point further includes an optical booster amplifier that includes an output coupled to the input of the 1×N splitter.

8. The broadcast network of claim 1 further comprising:
a central office;
wherein the branch point is located in the central office.

9. The broadcast network of claim 1 wherein the branch point is located in the field.

10. The broadcast network of claim 1 further including:
a second fiber optic cable for use in implementing route diversity.

11. The broadcast network of claim 1 further including:
d) at least one optical receiver for receiving one of the individual fibers.

12. The broadcast network of claim 1 further including:
d) a plurality of optical receivers; wherein each receiver is coupled to a respective individual fiber.

13. The broadcast network of claim 1 wherein the optical transmitter includes:
an optical source for providing an optical signal;
an optical modulator for receiving data signals, for receiving the optical signal, and for modulating the optical signal based on the data signals to generate a modulated optical signal.

14. The broadcast network of claim 13 wherein the optical transmitter further includes:
a multiplexer for receiving a plurality of data signals and based thereon for generated a multiplexed signal;
wherein the multiplexed signal is provided to the optical modulator.

15. The broadcast network of claim 11 wherein the optical receiver includes:
a photodetector for receiving a modulated optical signal that includes data signals, for demodulating the modulated optical signal to recover the data signals.

16. The broadcast network of claim 15 wherein the optical receiver further includes:
a de-multiplexer for receiving a recovered multiplexed data signal and based thereon for generating the individual data signals.

17. The broadcast network of claim 1 wherein the optical transmitter transmits the signal on all the individual fibers.

18. A method for broadcasting information through a broadcast network using a multi-optical-fiber cable that includes a plurality of individual optical fibers, the method comprising:
receiving a broadcast signal;
transmitting the broadcast signal through the multi-optical-fiber cable; and
delivering the broadcast signal to a respective user through a dedicated individual optical fiber.

19. The method of claim 18 further comprises the steps of:
using an optical receiver to receive the signal.

20. The method of claim 18 further comprises the steps of:
transmitting the same signal on all the individual fibers of the cable.
